(19) United States
(12) Patent Application Publication
(10) Pub. No.: US 2008/0022035 A1
(43) Pub. Date: Jan. 24, 2008

(54) RECORDABLE DEVICE THAT COULD RECORD FLASH DISKS WITHOUT COMPUTERS

(75) Inventors: Hong Chi Yu, Zhongho City (TW); Ting Yu Cho, Kaohsiung (TW)

Correspondence Address: ANTHONY R. BARKUME, 20 GATEWAY LANE, MANORVILLE, NY, 11949, US

(73) Assignee: OMNIDIRECTIONAL CONTROL TECHNOLOGY, INC., Hsin-tien City (TW)

(21) Appl. No.: 11/762,131

(22) Filed: Jun. 13, 2007

(30) Foreign Application Priority Data
Jul. 21, 2006 (TW) 095212907

(51) Int. Cl. G06F 12/16; G06F 13/42

(52) U.S. Cl. 711/103; 710/105; 711/E12.103

(57) ABSTRACT

The present invention is related to a recordable device that can record flash disks without computers. There are two slots for general serial buses. Two flash disks can insert into these two slots for mutual copy. A control circuit chooses the file format and the file date according to the selections from the first function key and the second function key and executes the copy command to copy files between the two flash disks. The control circuit controls LED indicators to indicate when the copy command has been executed.

### FIELD OF THE INVENTION

The present invention is related to a recordable device, more particularly to a recordable device that can record flash disks without computers.

### BACKGROUND OF THE INVENTION

The technology of computer industry develops rapidly and progressively. So the computer peripherals develop fast too to meet the requirements of people. For example, the flash disk, which is portable and can be used as a storage device, can save computer data easily.

In some conditions, one only need to copy data between two flash disks, for instance, copy some media files or graphics files between two flash disks. If we must rely on big-sized computer to finish such tasks, it would be very troublesome and inconvenient.

FIG. 1 illustrates the procedures of handling the conventional USB OTG. The USB OTG (Universal Serial Bus On Controller)(10) is powered by the adaptor (12) and the battery (14). There are two slots (16) on the side of the USB OTG. We can insert two flash disks (18,20) into the slots (16). Then use the button (22) on the USB OTG to operate the data copy and use the LED (24) on the USB OTG to show the status of the process. The prior USB OTG (10) can only copy all files from the devices. However, the flash disk is growing bigger and bigger, from 32 M bytes to 2G bytes, and even bigger than 2 G bytes is now available. But copy from the flash disk with 2 G storage would require considerable amount of time. Additionally, copying the unwanted data would also waste disk space. The prior USB OTG controller has too few functions to satisfy the user's requirements.

To speed up the copy time, to improve the efficiency for the flash disk data storage Moreover, and to improve the user's convenience are the main topics in the present invention.

### SUMMARY OF THE INVENTION

An objective of the present invention is to propose a recordable device for flash disk specific files backup without computers.

Another objective of the present invention is to copy data between two flash disks with the data format options.

Another objective of the present invention is to reduce the copy time and to save the disk copy space.

### BRIEF DESCRIPTION OF THE INVENTION

The objective of the present invention is to provide a recordable device for saving flash disks files bypass the computer devices. Another objective of the present invention is to copy specific files by function keys.

Another objective of the present invention is to copy specific files with the same file format.

Another objective of the present invention is to copy specific files according to the file save date.

Another objective of the present invention is to reduce the copy time between two flash disks.

Another objective of the present invention is to improve the convenience for flash disks copy.

According to the present invention, a recordable device for recording flash disks without computers is proposed. The recordable device includes: a power supply for providing a power to the device; a first general serial bus slot for inserting a first flash disk; a second general serial buses slot for inserting a second flash disk; a first function key for selecting a file format to be copied; a second function key for selecting a file date to be copied; a copy key to order the copy between said first flash disk said second flash disk; an indicator light for indicating the copy action; and a control circuit for the execution of the copy between said first flash disk and said second flash disk according to said file date and said file format.

The present invention may best be understood through the following description with reference to the accompanying drawings, in which:

### BRIEF DESCRIPTION OF THE DRAWINGS

FIG. 1 illustrates the operation of the conventional USB OTG controller;

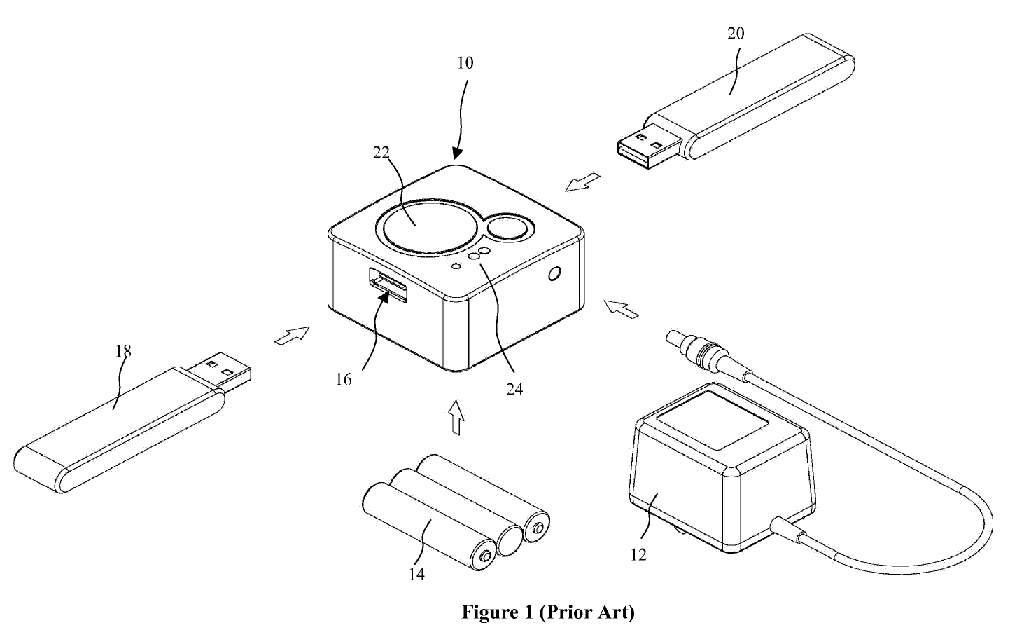

FIG. 2 illustrates an operation example of the recordable device;

FIG. 3 illustrates the side view corresponding to FIG. 2;

FIG. 4 illustrates the control circuit of the recordable device.

### DETAILED DESCRIPTION OF THE PREFERRED EMBODIMENT

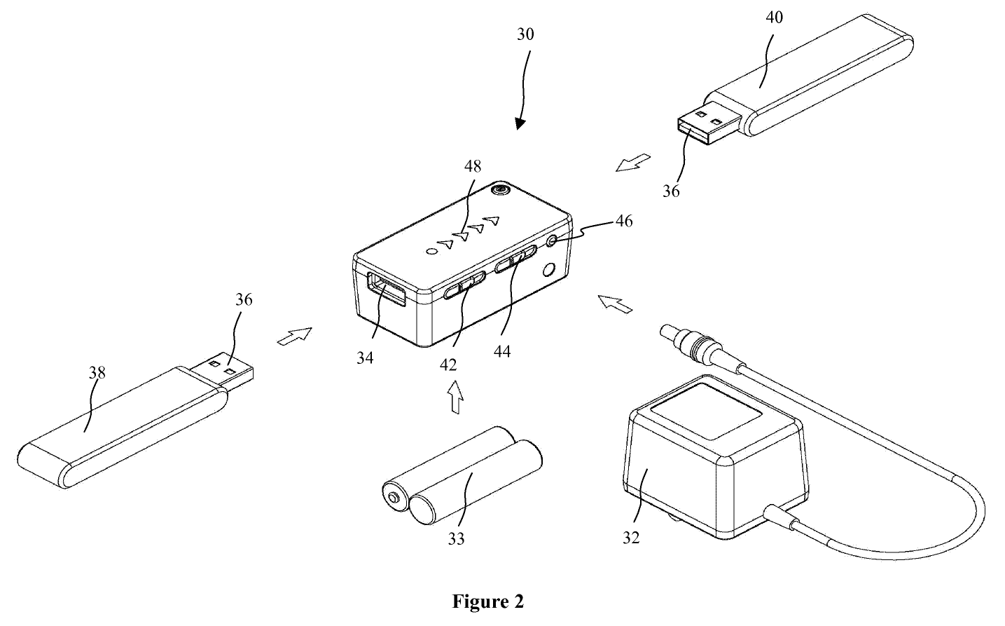

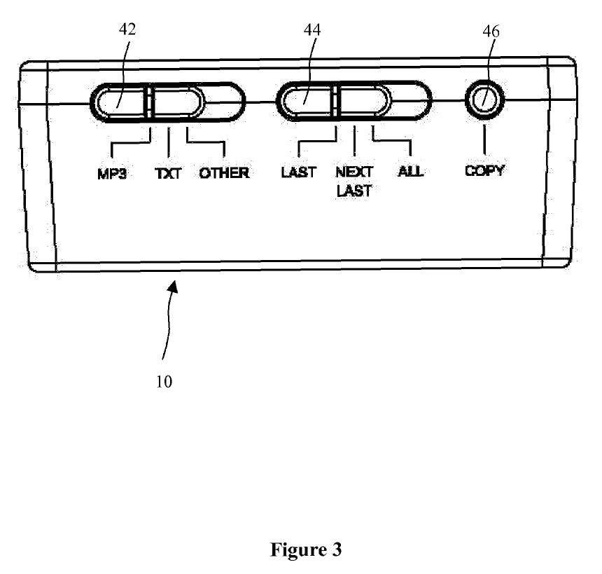

FIG. 2 illustrates the operation of the recordable devices according to the present invention. FIG. 3 is the side view of the recordable devices of FIG. 2. In FIG. 2 and FIG. 3 shows an external power connects to the recordable device (30). The power supply is an pwer adaptor (32); it will convert AC to DC to supply the power to the recordable device (30). Certainly, the power supply may be a battery (33) embedded in the recordable device (30).

The first general serial bus slot (34) and the second general serial bus slot (not showed on the drawing, corresponding to the side of the first general serial bus slot (34) of the recordable device (30)). Insert the first flash disk (38) into the first general serial bus slot (34) and insert the second flash disk (40) into the second general serial bus slot. Certainly, both the first flash disk and the second flash disk have a general serial bus plug (36).

The first function key (42) chooses a file format to be copied in the first flash disk (38). As illustrated in FIG. 3, the first function key (42) can select three file formats (mp3, txt, and other) and the second function key (43) can select three file dates (last, next last and all). For example, one can use first function key to choose MP3 format, TXT file format or other file formats. The 2nd function key (44) chooses the file dates in first flash disk (38). For example, one can choose the file that is last saved (LAST), the one that is previously saved, or all of the files (ALL) in the first flash disk 38.

Press the copy key (46) to execute the copy command between the two flash disks. The indicator light 48 shows the copy action on.

The control circuit of the recordable device 30+ selects the file format and the file date according to the first function key (42) and the 2nd function key (44), executes the copy command between the two flash disks according to the copy key (46), and also controls the LED indicator light (48) to indicate whether the copy command between the two flash disks is functioning well.

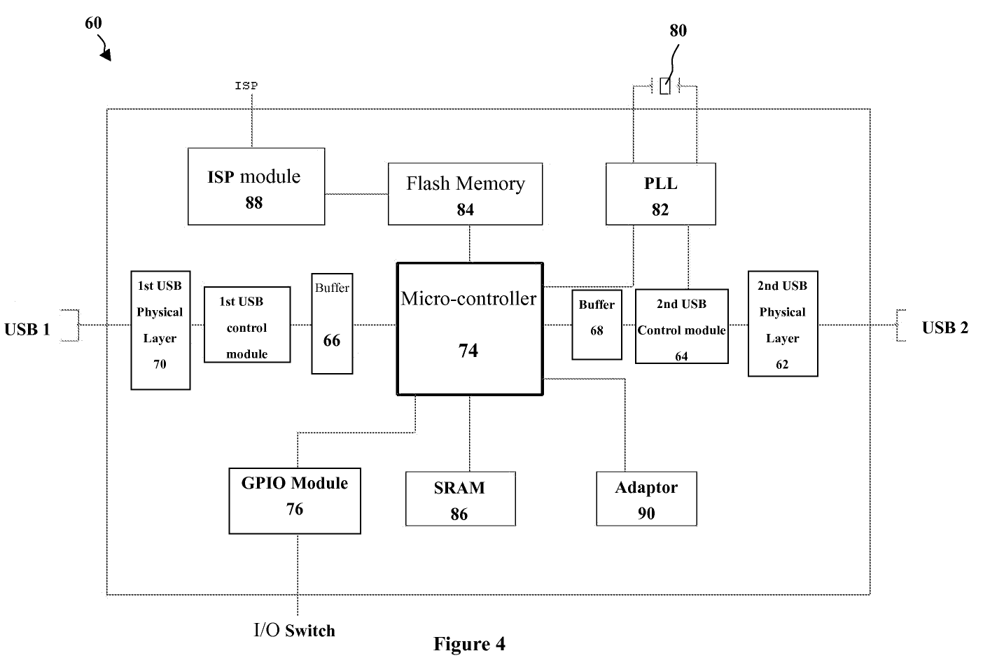

FIG. 4 is the block diagram of control circuit according to the present invention. In FIG. 4, the USB1 end of control circuit's (60) connects to the first flash disk (38), the USB2 end connects to the second flash disk (40), and the ISP (In System Programming) end programs the micro-controller. On the other hand, the GPIO (General Purpose 10) module (76) can control the copy mode by selecting on the I/O switch (such as the mp3, txt and other file formats).

Insert the first flash disk (38) for the source file into the first general serial bus slot (34), and insert the second flash disk (40) for the destination file into the 2nd general serial bus slot. When executing the copying command between the two flash disks (pressing the copy key 46), the micro-controller (74) will operate according to the definition of the first function key (42) and 2nd function key (44). And it will also correspond to the data on the GPIO end of GPIO module (76). The USB Physical Layer (70) and the control module (72) of the first USB device will convert the files which were read from the USB1 end connected to the flash disk which is going to be copied from and store it in the buffer (66). The micro-controller (74) will read from the buffer (66) and store the data on another buffer (68). The 2nd physical layer of USB device and the 2nd control module of USB device (64) will read files from buffer (68). Then it will convert the files to the USB2 end and copy to the flash disk that is going to be copied to the second flash disk (40).

In FIG. 4, the power adaptor (90) of the control circuit (60) supplies a stable voltage to the micro-controller (74). The oscillator (80) of the control circuit (60) will produce clock signal to a Phase Lock Loop (PLL) (82). The Phase Lock Loop (82) will synchronize micro-controller (74) with the 2nd USB control device module (64) by reading the clock signal. The flash memory (84) stores programs and data to be used by micro-controller (74). The micro-controller (74) can temporarily save its data on SRAM (86) when it is processing the command. ISP module 88 will update the data on the flash memory 84 with data received from the ISP end.

The objective of the present invention is to create a recordable device which will record the files on the flash disks through the use of function keys without computers. It will only copy certain files selected according to the file format and the file date. It will reduce the copy time and the disk space by copying only selected files as opposed to copying everything on the disk. It also offers more functions to the users.

In other words, the present invention is to provide the most efficient way for copying by designing the function keys that can be used by the users with the least amount of costs. At the same time, the function key is programmable to set up by the users for their needs. For instance, the file format in htm, php, and fla are most used by the web designer; thus, we can change the file formats in mp3, txt to htm and php, etc. Therefore, people in different professions can share files with each other easily and quickly. Of course, the function keys can increase to or more than 4 when there is need. The copy method proposed in the present invention is easy to operate. It requires only a few of the function keys as opposed to LCD display like other electronics products.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims that are to be accorded with the broadest interpretation so as to encompass all such modifications and similar structures.

What is claimed is:

1. A recordable device for recording flash disks without computers comprising:
a power supply for providing a power to the recordable device;
a first general serial bus slot for inserting a first flash disk;
a second general serial bus slot for inserting a second flash disk;
a first function key for selecting a file format in said first flash disk to be copied;
a copy key to order the copy between said first flash disk and said second flash disk;
an indicator light for indicating the copy action; and
a control circuit for the execution of the copy between said first flash disk and said second flash disk according to said file format selected by said first function key.

2. The device according to claim 1 wherein said power supply is an adaptor or a battery.

3. The device according to claim 2 wherein said adaptor converts a AC voltage to a DC voltage.

4. The device according to claim 1 further comprising a second function key for selecting a file date in said first flash disk to be copied.
